(19) United States
(12) Patent Application Publication
(10) Pub. No.: US 2011/0096868 A1
(43) Pub. Date: Apr. 28, 2011

(54) TRANSMISSION OF A PIECE OF MULTIMEDIA CONTENT ACROSS A NETWORK TO A TELECOMMUNICATION TERMINAL

(75) Inventors: Emmanuel Gustin, Saint-Quay Perros (FR); Claude Daloz, Lannion (FR)

(73) Assignee: France Telecom, Paris (FR)

(21) Appl. No.: 12/994,942

(22) PCT Filed: May 13, 2009
(86) PCT No.: PCT/FR2009/050880

§ 371 Date: Nov. 29, 2010

(30) Foreign Application Priority Data
May 30, 2008 (FR) 0853577

(51) Int. Cl. H04L 27/00

(52) U.S. Cl. 375/295

(57) ABSTRACT

A method is provided for transmitting at least one piece of multimedia content to at least one telecommunication terminal, comprising: a step of sending, by a transmitting device, a request to establish a communication link-up between the transmitting device and the terminal, said sending step being carried out after an instance of one event from a predetermined set of events, said terminal to be notified of said request; and a step of transmitting said piece of multimedia content across said link-up in the form of a telephone and/or television flow, said stage of transmission to be carried out after detecting the actual establishment of said link-up.

The invention relates to the field of telecommunications and more particularly to a method and a server for the transmission of a multimedia content through a network to a telecommunication terminal.

It is known to make a multimedia content available via a Web server. The user accesses the content by connecting to this server by means of a telecommunication terminal and then by downloading this content so as to take cognizance thereof.

Within the framework of the implementation of a service for broadcasting multimedia content associated with a particular event, for example a video relating to a sports event, it is known to dispatch a message to the terminal of the subscriber user so as to notify him of the occurrence of the event and the presence of a content to be downloaded. Usually the message comprises a URL (Uniform Resource Location) allowing access to this content.

However, this mode of broadcasting content is very inconvenient since it requires several successive actions on the part of the user: the user must consult his messaging, open the message received, and then select the URL contained in this message and finally establish a connection to a server associated with the selected URL.

Consequently, this mode of broadcasting does not allow real-time broadcasting of information since the content becomes available only after the user has executed these various actions.

A requirement is therefore apparent for a multimedia content broadcasting solution allowing any type of multimedia content to be made available in a fast and simple manner.

One of the aims of the invention is to remedy problems and drawbacks of the prior art and/or to afford improvements thereto.

The subject of the invention is, according to a first aspect, a method for transmitting at least one multimedia content to at least one telecommunication terminal, comprising
a step of dispatching by a sender device a request to establish a communication link between the sender device and the terminal, said dispatching step being executed subsequent to an occurrence of an event from among a predetermined set of events, said request being intended to be notified to said terminal,
a step of transmitting said multimedia content through said link in the form of a telephonic and/or televisual stream, said transmission step being intended to be executed after detection of the actual establishment of said link.

The invention considerably simplifies for the user the mode of access to the multimedia content, since it suffices, on receipt by the terminal of a notification of request to establish the link, that the user of this terminal go off-hook in order for the communication to be established and for him to be able to listen to and/or view the multimedia stream transmitted.

The subject of the invention is also, according to a second aspect, a device for transmitting at least one multimedia content to at least one telecommunication terminal, comprising
means for dispatching a request to establish a communication link through said network between the device and the terminal, said dispatching means being intended to be activated subsequent to an occurrence of an event from among a predetermined set of events, said request being intended to be notified to said terminal,
means for transmitting said multimedia content through said link in the form of a telephonic and/or televisual stream, said transmission means being intended to be activated after detection of the actual establishment of said link.

The advantages stated for the method according to the invention are directly transposable to the server according to the invention.

According to a preferred implementation, the various steps of the method according to the invention are implemented by computer software or a program, this software comprising software instructions intended to be executed by a data processor of a server and being designed to control the execution of the various steps of this method.

Consequently, the invention is also aimed at a program, able to be executed by a computer or by a data processor, this program comprising instructions for controlling the execution of the steps of a method such as mentioned hereinabove.

This program can use any programming language, and be in the form of source code, object code, or code intermediate between source code and object code, such as in a partially compiled form, or in any other desirable form.

The invention is also aimed at an information medium readable by a computer or data processor, and comprising instructions of a program such as mentioned hereinabove.

The information medium may be any entity or device capable of storing the program. For example, the medium can comprise a storage means, such as a ROM, for example a CD ROM or a microelectronic circuit ROM, or else a magnetic recording means, for example a diskette (floppy disk) or a hard disk.

Moreover, the information medium may be a transmissible medium such as an electrical or optical signal, which may be conveyed via an electrical or optical cable, by radio or by other means. The program according to the invention may be in particular downloaded from a network of Internet type.

Alternatively, the information medium may be an integrated circuit into which the program is incorporated, the circuit being adapted for executing or for being used in the execution of the method in question.

According to another implementation, the invention is implemented by means of software and/or hardware components. With this in mind, the term module can correspond in this document equally well to a software component or to a hardware component. A software component corresponds to one or more computer programs, one or more subroutines of a program, or more generally to any element of a program designed to implement a function or a set of functions. A hardware component corresponds to any element of a hardware set designed to implement a function or a set of functions.

Other aims, characteristics and advantages of the invention will be apparent through the description which follows, given solely by way of nonlimiting example and with reference to the appended drawings in which:

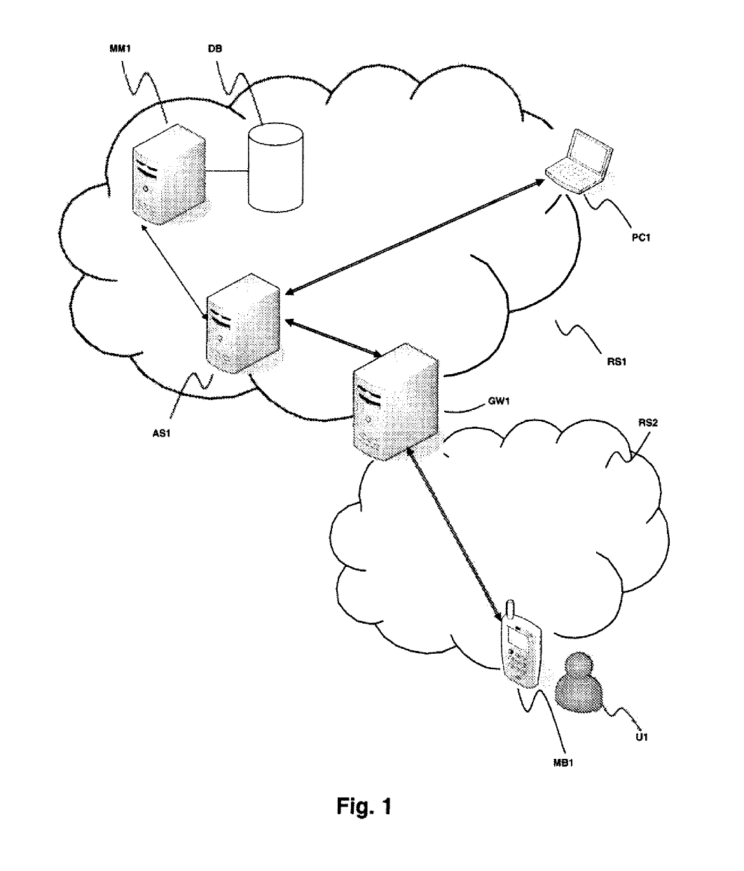

FIG. 1 represents in a schematic manner a communication system integrating a server according to the invention;

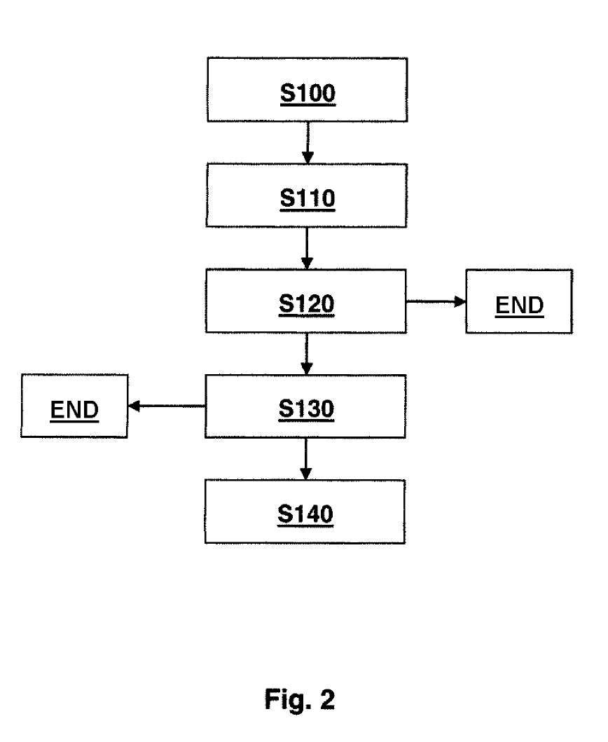

FIG. 2 represents a flowchart of a mode of practice of the method according to the invention.

The invention is described in the context of its application to a multimedia content broadcasting service.

The system of FIG. 1 is a simplified representation of a communication system for the implementation of the invention.

This system comprises:
a first network RS1 for data transmission, in this instance the Internet network,
a second network RS2 for data and telephony transmission, in this instance a mobile network, for example of UMTS type;
an application server AS1,
a multimedia content server MM1,
a database DB,
a gateway GW for interconnection between the network RS1 and the network RS2,
a mobile terminal MB1, of mobile telephone type,
a fixed terminal PC1, of personal computer type.

The multimedia content server MM1 is associated with a database DB making it possible to store the various multimedia contents to be transmitted during the implementation of the service. A multimedia content is for example a sound file, a photo, a video, a text document or an arbitrary combination of these elements.

According to the invention, the multimedia content is transmitted in the form of a telephonic and/or televisual stream. It is therefore assumed that the terminal MB1 is capable of receiving such a stream and that the data transmission network RS2 allows the transmission of such a stream. In this instance, a UMTS network allows the establishment of telephonic communications or of videophonic communications, and therefore the conveying of telephonic and/or televisual streams (audio and/or video streams, in the broad sense). The terminal used for the implementation of the service is assumed to be a terminal capable of receiving such communications, for example a 3G (so-called third-generation) mobile terminal. Some other type of terminal, fixed or mobile, having identical capabilities is also usable.

The multimedia content server MM1 comprises a communication module for communicating by messages with the application server AS1. In particular, when a new multimedia content is recorded by the content server MM1 and available for a transmission, the control module signals to the application server AS1 the availability of this new content, by dispatching a message thereto identifying and/or describing this new content.

The application server AS1 is a Web server offering a multimedia content broadcasting service.

Access to the service offered by this server is possible, in a known manner, by connection established through the network RS1 between a terminal and this server. When access to the application server AS1 is performed by means of a mobile terminal, which like the mobile terminal MB1 does not access the network RS1 directly, the connection between the terminal and the server is established in a known manner through the network RS2, and then through the interconnection gateway GW and finally the network RS1.

This same user U1 is able to access the application server AS1 by means of his fixed terminal PC1 connected to the network RS1. In this case, the link between the fixed terminal PC1 and the application server AS1 is established via the network RS1 without passing through the gateway GW1.

Access to the service assumes prior recording, for each user U1, of a user profile in which are specified:
the multimedia content or contents that the user U1 wishes to receive,
an identifier of the terminal of the user U1 to which these contents are to be transmitted, and
the mode of triggering of the transmission of each of these contents.

The user U1 defines his profile and transmits the associated data to the application server AS1 by connecting, by means of the mobile terminal MB1 or of the terminal PC1, to a Web site managed by the application server AS1.

The application server AS1 comprises in particular a module for managing user profiles for storing, for each user of the service, the selected multimedia content or contents, and for each selected content the mode of triggering chosen by the user for the transmission of this content as well as the associated dates and times, if any.

The selection of the contents that the user U1 wishes to receive is performed for example by selection from a list of contents that are available or are defined as a function of forthcoming events. The list of available contents is provided by the application server AS1 as a function, on the one hand, of the contents available via the content server MM1, that is to say already present in the database DB, and, on the other hand, of contents that it is envisaged will be generated upon predefined events. For example, the user can choose to receive all the videos showing the goals scored during a football tournament. In this case, a video will be generated for each goal scored, this video being stored thereafter in the database DB of the content server MM1. In this way the list of contents that are able to be transmitted is enriched dynamically, as and when predefined events occur.

The mode of triggering of the transmission of a content is for example chosen from among the following list of possible modes of triggering:
fixed-date triggering, that is to say upon the occurrence of a predefined date and time;
periodic triggering, that is to say at regular time intervals from an occurrence of a predefined start date and time;
triggering upon foreseeable event, that is to say upon the occurrence of an event whose time and date are unknown but whose occurrence is certain; this type of event makes it possible for example to dispatch a content relating to the finish of a cycle race, and to do so whatever time the latter terminates;
triggering upon a random event, that is to say upon the occurrence of an event whose time and date are unknown and whose occurrence is random; this type of event makes it possible for example to dispatch a content relating to a goal scored during a football match, it being possible for this event not to occur.

For fixed-date triggering, the user must specify a date and time for the transmission of the selected multimedia content. For periodic triggering, the user must specify a start date and time and a periodicity. For the other modes of triggering, the user does not have any date or time to specify.

The application server AS1 furthermore comprises a drive module for detecting an occurrence of an event from among a predetermined set of events and for activating the send module subsequent to an occurrence of such an event. The set of events able to be detected by the application server AS1 comprises all the dates and times associated with a mode of fixed-date or periodic triggering, as well as the events associated with the making available of a new content associated with a mode of triggering upon a foreseeable event or a mode of triggering upon a random event.

The application server AS1 comprises a communication module for generating a telephonic or videophonic call to a terminal, that is to say for sending a request to establish a telephonic or videophonic link through the network RS1, and optionally through another network RS2, this link having to be established between this application server AS1 and a terminal whose number is dialed. This link establishment request is manifested, in a known manner, by the sending, by an item of equipment of the network RS2 to which the addressee terminal is connected, of a call notification signal. If the user of this addressee terminal goes off hook, the link is, in a known manner, automatically established.

The notification of the request is transmitted to the terminal, accompanied by an item of information relating to the multimedia content intended to be transmitted. This may be performed using OIP (“Originating Identity Presentation”) technology which makes it possible to give an item of information about the sender of a call or any other item of information relating to this call. This advantageously makes it possible to advise the user of the addressee terminal about the nature of the call and about the multimedia content intended to be transmitted, and to do so even before the link is established.

The communication module of the application server AS1 is also designed to interrupt such a link.

The application server AS1 furthermore comprises a detection module for detecting whether a telephonic or videophonic link is actually established subsequent to the sending of a request to establish such a link. The detection module is also designed to detect an interruption of such a link.

The detection module consists for example of a coupling device allowing the analysis of the call establishment signaling sent through the network RS1 or RS2 and reaching the application server AS1 through an interface for access to the network RS1. This signaling is performed, depending on the type of network used, either by dispatching a digital message or analog signals, these signals being standardized so as to be identifiable and recognizable.

Finally, the application server AS1 comprises a multimedia content transmission module designed to transmit through a telephonic or videophonic link a content in the form of a telephonic and/or televisual stream. Stated otherwise, the content is transmitted in the form of a continuous stream (“streaming” as it is known) in such a way that said content is audible and/or viewable by a user of the terminal when the telephonic or videophonic link is established.

The invention lends itself to other modes of practice. In particular, the functions implemented by the application server AS1 and the content server MM1 may be implemented by one and the same server. Some other splitting of the functions between these two servers is also conceivable.

The multimedia content transmission module can for example be integrated into the content server MM1.

Steps S100 to S150 of the method according to the invention are described in greater detail by reference to FIG. 2. This method is implemented by the application server AS1.

In the initial step S100, the drive module of the application server AS1 is active with a view to the detection of an event from among a predefined set of events. In the case of detecting one of these events, the next step S110 is executed.

In step S110, in the case of detecting an occurrence of an event from among the set of events to be detected, the drive module interrogates the profile management module so as to determine, as a function of the event detected, which multimedia content is to be transmitted and to which terminal this content must be transmitted. It is assumed hereinafter that this terminal is the mobile terminal MB1.

In step S120, the communication module of the application server AS1 generates a call to the terminal identified in step S110. Next, the detection module is activated so as to detect actual establishment of the communication link, telephonic or videophonic, with the mobile terminal MB1. In the case of actual establishment of the communication link, that is to say if the user of the mobile terminal MB1 goes off hook, the next step S130 is executed. In the converse case, the method terminates.

In step S130, the transmission module of the application server AS1 is activated subsequent to an actual establishment of the communication link and begins the transmission of the multimedia content in the form of a telephonic and/or televisual stream.

The detection module remains active during this transmission with a view to detecting a possible cutoff of the communication link. In the case of detection of a cutoff or interruption of the communication, that is to say in the case where the user of the mobile terminal MB1 goes on-hook, the transmission module interrupts the transmission of the multimedia content and the method terminates. In the converse case, the next step S140 is executed.

In step S140, the transmission module of the application server AS1 continues the transmission until the multimedia content is transmitted in its entirety. When said content has been fully transmitted, the communication module interrupts, on command of the transmission module, the established communication link.

As a supplement to the mode of practice described hereinabove, provision may be made for the application server AS1 to also fulfill the functions of network messaging server. In this case, the multimedia content or contents are transmitted to the user through a telephonic or videophonic link, established between the server and the terminal of the user, this link being, in this case, established on the initiative of the user of the terminal.

The process runs for example as follows:
the server receives a notification of request to establish a telephonic or videophonic link with a terminal,
when the terminal sending the call is a terminal authorized to access the service, the server accepts said request (that is to say goes off hook), the link then being established automatically,
the server transmits at least one part of a multimedia content already transmitted to this terminal or to which the user has subscribed, through the newly established link, still in the form of a telephonic and/or televisual stream.

The invention is applicable to the transmission of any type of multimedia content and to any type of telecommunication terminal. It considerably simplifies for the user the mode of access to the multimedia content.

1. A method for transmitting at least one multimedia content to at least one telecommunication terminal, comprising steps of:
dispatching by a sender device a request to establish a communication link between the sender device and the terminal, said dispatching step being executed subsequent to an occurrence of an event from among a predetermined set of events, said request notifying said terminal,
transmitting said multimedia content through said link in a form of at least one of a telephonic and televisual stream, said transmission step being executed after detection of an actual establishment of said link.

2. The method as claimed in claim 1, wherein said transmission stops in a case of detection of an interruption of said link.

3. The method as claimed in claim 1, wherein said link is interrupted when said content has been fully transmitted.

4. The method as claimed in claim 1, wherein a notification of said request is transmitted to said terminal, accompanied by an item of information relating to said content.

5. The method as claimed in claim 1, further comprising steps of:
receiving by the sender device a notification of request to establish another communication link through said network between the sender device and another terminal,
establishing said other link when said other terminal is an authorized terminal, and
transmitting at least one part of said multimedia content through said other link in a form of at least one of a telephonic and televisual stream.

6. A device for transmitting at least one multimedia content to at least one telecommunication terminal, comprising means for:
dispatching a request to establish a communication link through said network between the device and the terminal, said dispatching means being activated subsequent to an occurrence of an event from among a predetermined set of events, said request notifying said terminal, and
transmitting said multimedia content through said link in a form of at least one of a telephonic and televisual stream, said transmission means being activated after detection of an actual establishment of said link.

7. The device as claimed in claim 6, further comprising means for detecting the actual establishment of said link and the interruption of said link.

8. The device as claimed in claim 6, further comprising means for interrupting said link that is activated when said content has been fully transmitted.

9. A non-transitory computer program product comprising software instructions for the implementation of the method as claimed in claim 1 when said program is executed by a data processor.

10. A recording medium readable by a data processor on which is recorded a program comprising program code instructions for the execution of the steps of a method as claimed in claim 1.
